(19) United States
(12) Patent Application Publication
(10) Pub. No.: US 2008/0062461 A1
(43) Pub. Date: Mar. 13, 2008

(54) Print apparatus monitoring method, print apparatus monitoring system, and program therefor

(75) Inventors: Fusahiro Shiono, Osaka (JP); Ryoji Murata, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/897,079

(22) Filed: Aug. 29, 2007

(30) Foreign Application Priority Data
Sep. 13, 2006 (JP) 2006-247628

(51) Int. Cl. G06F 3/00

(52) U.S. Cl. 358/1.15

(57) ABSTRACT

A print apparatus monitoring system is provided that the operation state of a plurality of print apparatuses selected and used by a user can be known by resident display. In the method, prints are made by a plurality of print apparatuses connected through a network according to a print instruction from a terminal apparatus, and the operation states of the plurality of the print apparatuses instructed to make prints are displayed as separate icons respectively corresponding to the print apparatuses on a resident displaying portion of the terminal apparatus. For example, occurrence of an error in the print apparatuses is displayed by changing the display form of the corresponding icon. The display of the icon on the resident displaying portion can be displayed at the start of the printing in each print apparatus and can be erased at the end of the printing in each print apparatus.

### CROSS-NOTING PARAGRAPH

This Non-provisional application claims priority under 35 U.S.C. §119 (a) on Patent Application No. 2006-247628 filed in JAPAN on Sep. 13, 2006, the entire contents of which are hereby incorporated herein by reference.

### FIELD OF THE INVENTION

The present invention relates to a print apparatus monitoring method, print apparatus monitoring system, and program therefor that monitor state of print apparatuses when a plurality of print apparatuses connected to a network is used for printing.

### BACKGROUND OF THE INVENTION

Recently, a user selects predetermined print apparatuses from a plurality of print apparatuses connected to each other through a network to print one document with a plurality of print apparatuses in a distributed manner in a short time or to concurrently print different documents with a plurality of print apparatuses. Since the statuses of a plurality of the selected print apparatuses can normally be displayed as dialogue on a terminal apparatus with the use of a monitor utility, a user can know the progress of printing, the number of print copies, etc.

To display the progress of printing, the monitor utility must be activated at each time of the display, that is cumbersome operations for a user, and if the utility is always activated, not only a network load but also a processing load of a computer are increased. If other operations such as document making are concurrently performed, display areas of other applications are narrowed down by the display window for the monitoring. In a proposed method for solving this problem, for example, resident display of the progressing conditions of printing of a printer is performed as an icon on a resident displaying portion (e.g., Japanese Laid-Open Patent Publication No. 2005-44080).

By displaying a printing state of a printer as an icon on the resident displaying portion as disclosed in Japanese Laid-Open Patent Publication No. 2005-44080, a user can always comprehend the printing state from the displaying portion, although that portion is a small limited area, and can execute other applications by constantly monitoring the start and end of the printing, occurrence of errors, etc., at the same time. However, in Japanese Laid-Open Patent Publication No. 2005-44080, if a plurality of printers is used, a printer displayed as an icon is limited to one default printer. Therefore, to display the status, etc., of another printer, another printer must be set to be the default printer, or the dialog display or display window must be opened, and therefore, the display operations are cumbersome.

### SUMMARY OF THE INVENTION

It is the object of the present invention to provide a print apparatus monitoring method, print apparatus monitoring system, and program therefor that make it possible to comprehend all operation states of a plurality of print apparatuses selected and used by a user through resident display.

The print apparatus monitoring method of the present invention is a method of making prints with a plurality of print apparatuses connected through a network in accordance with a print instruction from a terminal apparatus and monitoring the states of the print apparatuses with the terminal apparatus, and the operation states of a plurality of the instructed print apparatuses are separately displayed in a resident displaying portion of the terminal apparatus as different icons corresponding to the respective print apparatuses. For example, occurrence of an error in a print apparatus is displayed by changing a display form of the corresponding icon. The icon display on the resident displaying portion can be performed such that the display is started at the start of the printing in each print apparatus and disappears at the end of the printing in each print apparatus.

The icons are displayed so that each utilized print apparatus can be identified, and a mark can be added to the display such that a type of application sending the print instruction can be identified. The icons may be displayed so that they can distinguish whether printing is performed for the same print data in a distributed manner or for different print data. If the same print data are printed in a distributed manner, it is desirable to display a print completion notification when all the print apparatuses complete the printing. If the number of concurrently operating print apparatuses becomes greater than a predetermined number, it is desirable to expand the display area of the icon display.

The print monitoring system and the program of the present invention is a print monitoring system making prints with a plurality of print apparatuses connected through a network according to a print instruction from a terminal apparatus and monitoring the print states thereof with the terminal apparatus and displaying the operation state of a plurality of the print apparatuses instructed to make prints as separate icons respectively corresponding to the print apparatuses on the resident displaying portion of the terminal apparatus, and a program that is programmed to operate on a computer.

### BRIEF DESCRIPTION OF THE DRAWINGS

FIG. 1 depicts an outline of a print system according to the present invention;

FIG. 2 is a block diagram of an example of an internal configuration of a terminal apparatus used in the present invention;

FIG. 3 is a block diagram of an example of an internal configuration of a print apparatus used in the present invention;

FIG. 4 is an explanatory flow diagram of an embodiment of the present invention;

FIG. 5 depicts a display example of icons for the print apparatuses in the flow of FIG. 4;

FIG. 6 depicts a display example when identifying the print apparatuses with the icons of FIG. 5;

FIG. 7 is an explanatory flow diagram of an embodiment of displaying the application utilized;

FIG. 8 depicts a display example when identifying the print apparatuses in the flow of FIG. 7;

FIG. 9 is an explanatory flow diagram of an embodiment including distributed printing;

FIG. 10 depicts a display example when identifying the print apparatuses in the flow of FIG. 9;

FIG. 11 is an explanatory flow diagram of an embodiment using a predetermined number or more of print apparatuses; and

FIG. 12 depicts a display example when identifying the print apparatuses in the flow of FIG. 11.

### PREFERRED EMBODIMENTS OF THE INVENTION

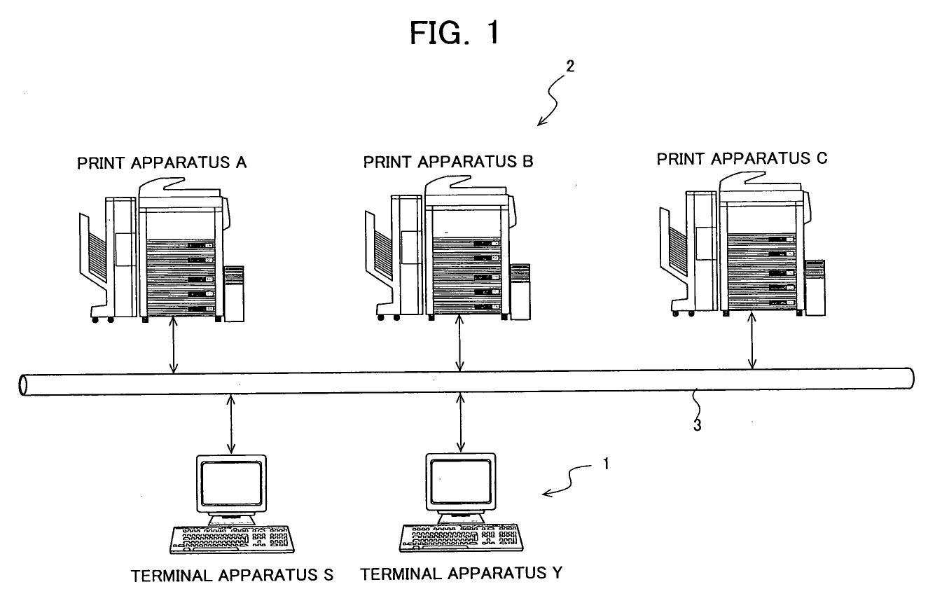

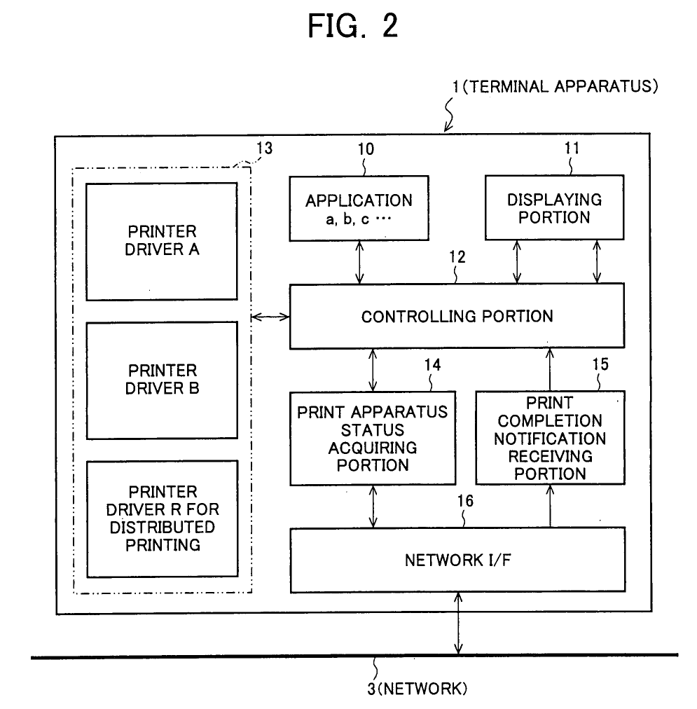

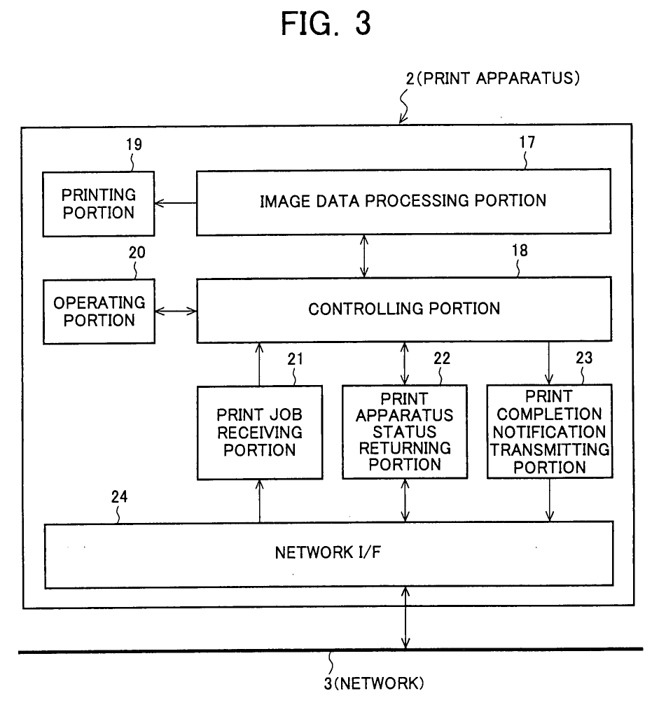

Embodiments of the present invention will be described with reference to the accompanying drawings. FIG. 1 depicts an outline configuration of a print system according to the present invention; FIG. 2 is a block diagram of an example of an internal configuration of a terminal apparatus which gives the instruction of printing; and FIG. 3 is a block diagram of an example of an internal configuration of a print apparatus which executes printing.

As shown in FIG. 1, in a print system according to the present invention, a plurality of terminal apparatuses 1 and a plurality of print apparatuses (printer) 2 are connected to a network 3 so that they can communicate with each other. A plurality of the terminal apparatuses 1 connected to the network 3 can include not only client terminals (Y) but also a server terminal (S) that manages the printing and the print apparatuses 2 can be a fax machine including a print function as well as a typical dedicated machine for printing and multi-function peripherals including a copy function.

The terminal apparatus 1 used in the print system of the present invention can select a plurality of the print apparatuses 2 (A, B, C . . . N) and give the instructions of printing the print data with different applications to them and print a plurality of application data at the same time. If a number of copies are made from the same print data, the terminal apparatus 1 can select a plurality of the print apparatuses and give the instructions of printing to them and execute the distributed printing to complete the printing in a short time.

As shown in FIG. 2, a configuration example for the printing in the terminal apparatus 1 includes a plurality of applications 10, an interface (UI) displaying portion 11 that performs guide display for printing operations, print setting display, print status display, etc., and a controlling portion 12 that controls display of the displaying portion 11. The terminal apparatus 1 also includes a plurality of printer drivers 13 (A, B . . . N) for selecting and driving the predetermined print apparatuses 2 (A, B . . . N) to perform predetermined operations. The terminal apparatus 1 also includes a printer driver R for the distributed printing, which is used for driving each of two printers to respectively print 50 brochures when printing 100 brochures, for example. These printer drivers 13 drive the predetermined print apparatuses 2 (A, B . . . ) connected through the controlling portion 12 to the network 3 to perform printing and notify the displaying portion 11 of the start of the printing through the controlling portion 12.

The terminal apparatus 1 includes a print apparatus statues acquiring portion 14 for acquiring information of whether the print apparatus 2 on the network 3 is currently printing, performing job, or being ready for printing, or for acquiring information that an error has been occurring, and can display the information on the displaying portion 11 through the controlling portion 12. The terminal apparatus 1 also includes a print completion notification receiving portion 15 that receives a notification of print completion when the print instruction sent from the terminal apparatus 1 is executed by the print apparatus 2, and can display the notification on the displaying portion 11 through the controlling portion 12. The terminal apparatus 1 also includes a network interface (I/F) 16 that connects it to the network 3 to enable communication with the print apparatuses 2.

A configuration example of the print apparatus (printer) 2 includes a configuration shown in FIG. 3 and various types of printers such as color printers, monochrome printers, and digital multi-function peripherals can be used as the print apparatus 2. The print apparatus 2 includes an image data processing portion 17 that executes image processing of print data received from the network 3 to generate image data, a controlling portion 18 that controls these operations, a printing portion 19 that prints the image data, and an operating portion 20 that executes operations of print setting, etc.

The print apparatus 2 also includes a print job receiving portion 21 that receives the print data and print job transmitted from the terminal apparatus, a print apparatus status returning portion 22 that returns the state of the print apparatus 2 (e.g., printing, performing job, or being ready for printing) to the outside, and a print completion notification transmitting portion 23 that notifies a sender of the completion of the received print instruction, and each of these portions are connected to the controlling portion 18. The print apparatus 2 is connected to the network 3 and also includes a network interface (I/F) 24 to enable communication with the terminal apparatus 1.

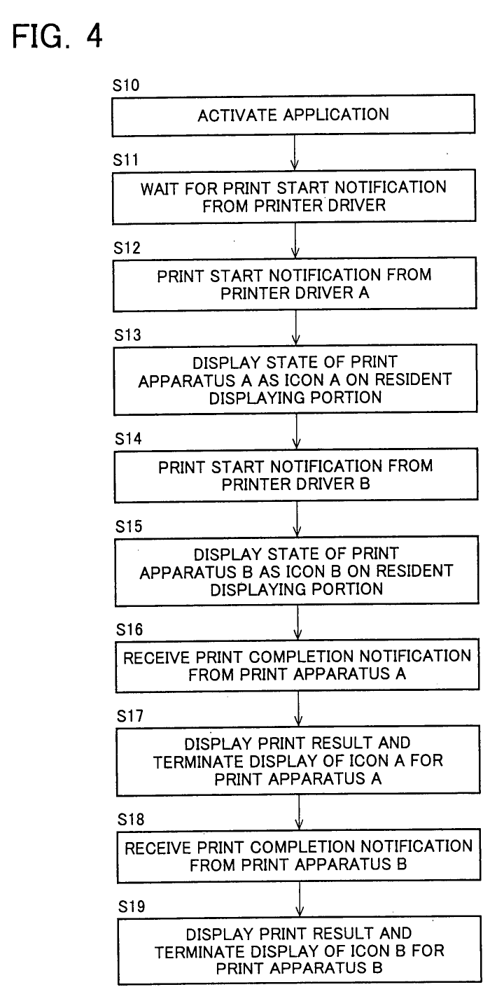

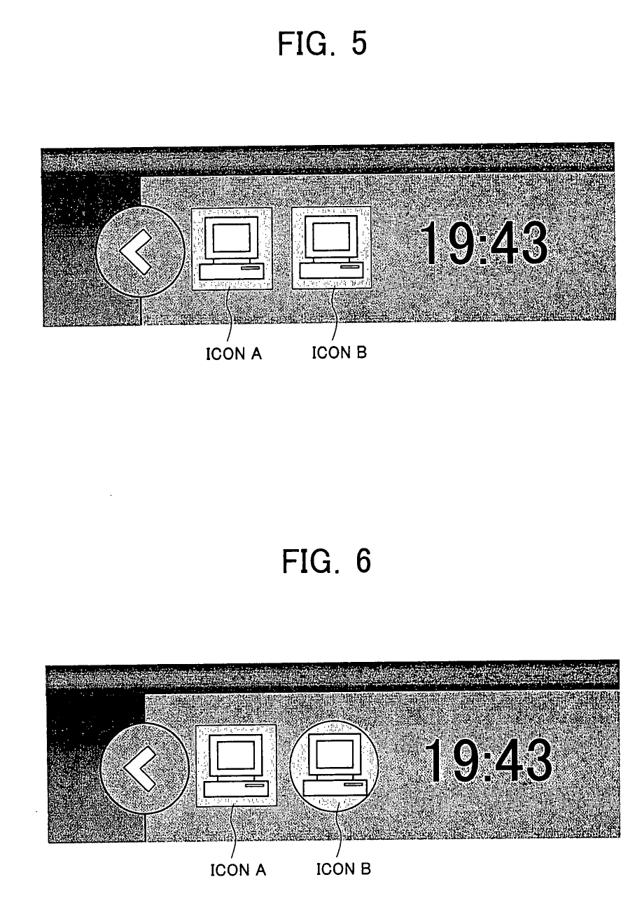

A specific embodiment of the print apparatus monitoring method according to the present invention will be described with reference to a flow of FIG. 4 and display examples of FIG. 5. The embodiment of FIGS. 4 and 5 can be considered as a basic form of the present invention. In the embodiment, when the printing is executed using a plurality of the print apparatuses by concurrently sending print instructions (print directions) to them, all the print apparatuses are separately indicated in a resident displaying portion of the terminal apparatus as different icons each of which corresponds to each of all the print apparatuses on use, respectively.

An outline of the print apparatus monitoring method according to the present invention is described below with reference to the flow of FIG. 4, that is, for example, first, at step S10, a user activates the applications 10a and 10b on the terminal apparatus to display print data to be printed, etc. A plurality of the applications 10a and 10b can be activated at the same time or, an application 10b can be activated after the print process progressed to some extent.

At step S11, the printer driver 13A (FIG. 2) for the print apparatus 2A is selected and activated to use the print apparatus 2A (see FIG. 1) to print the print data of the application 10a displayed on the terminal apparatus, and the printer driver 13B for the print apparatus 2B is selected and activated to use the print apparatus 2B to print the print data of the application 10b. While these print drivers are activated, the terminal apparatus 1 is in the waiting state for a print start notification.

When the printer driver 13A of the terminal apparatus is activated and the print apparatus 2A enters into the operation start state, a print start notification is sent out from the printer driver 13A at step S12. An icon A is made appear and displayed on the resident displaying portion of the displaying portion of the terminal apparatus to display that the print apparatus 2A is in an operating condition at step S13. When the printer driver 13B is then activated and the print apparatus 2B enters into the operation start state, a print start notification is sent out from the printer driver 13B at step S14. The icon B is appeared and displayed on the resident displaying portion of the displaying portion of the terminal apparatus to display that the print apparatus 2B is in an operating condition at step S15 such that the icon B is arranged next to the icon A which is already displayed.

If the printing by the print apparatus A is completed, the print completion notification is sent out from the print apparatus A at step S16, and the terminal apparatus receives this notification. When receiving this print completion notification, at step S17, the print result of the print apparatus A is displayed on the displaying portion of the terminal apparatus and the display of the icon A indicating the print apparatus A is terminated on the resident displaying portion. When a print completion notification is sent out from the print apparatus B and received by the terminal apparatus, the print result of the print apparatus B is displayed on the displaying portion of the terminal apparatus, and the display of the icon B indicating the print apparatus B is terminated on the resident displaying portion at steps S18 and S19 in the same manner as that in the case of steps S16 and S17.

FIG. 5 depicts the state when the icons indicating the print apparatuses are displayed on the resident displaying portion of the terminal apparatus described in the above flow. In FIG. 5, it is assumed that the icons A and B correspond to the print apparatuses A and B, respectively. The icons A and B are displayed next to next and can display that the print apparatuses A and B corresponding to the icons A and B are currently used by the terminal apparatus and in the print operations.

The operation statuses of the print apparatuses (e.g., printing, being ready for printing, occurrence of error, etc.) can be displayed by changing the display form of the icons A and B. Especially, if the device is stopped due to running out of paper, a paper jam in the print apparatus, etc., a user must be notified of such a situation to take action for fault recovery. Therefore, it is preferable to at least display the error using the displayed icons.

For example, the error display can be performed by a method of changing the display state of the icon itself, such as changing the icon display in the normal operation state into the display of icon of different shape or pattern, the display of icon with different color or luminance, the display of icon with different background, or the display of icon with a x-mark added. Alternatively, other display forms can be utilized, such as displaying the icon blinking and giving the icon a motion like moving images, to facilitate visual recognition. In another method, a warning buzzer or a warning lamp may be used for notification in addition to an icon. Since various types of error may be considered when an error occurs, pop-up display for details of the error may be activated by clicking the icon in the case of the error display.

It is preferable that the icons A, B . . . are displayed on the resident displaying portion only after the print apparatuses A, B . . . are selected and enter into the activated state. The activation of the print apparatus can easily be detected by receiving the print start notification from the printer driver. It is preferable that the display of the icons A, B . . . on the resident displaying portion is erased when the printing of the print apparatuses A, B . . . is completed and terminated. The termination of the operation of the print apparatus can easily be detected by receiving the print completion notification from the printer driver with the displaying apparatus.

As described above, since the icons A, B . . . are not displayed on the resident displaying portion when the print apparatuses are not operated, many icons A, B . . . can be restrained from being displayed on the resident displaying portion having a small space. If the icons A, B . . . are not displayed, this can represent that no print apparatus is currently used.

FIG. 6 is an example of the display that enables identification of what print apparatuses are displayed by the icons A, B . . . displayed on the resident displaying portion. In the example of FIG. 6, the backgrounds of the icons A and B are rectangular and circle, respectively, and the displayed print apparatuses can be identified by changing the display form of the icons. In other cases, the print apparatus can also be identified by changing the shape or pattern of the icon itself or by changing the display color or luminance of the icon, as described in the example of the error display of FIG. 5. By displaying the print apparatus in an identifiable manner, the detailed status of the print apparatus can be displayed as pop-up, or the print display having an error can easily be identified.

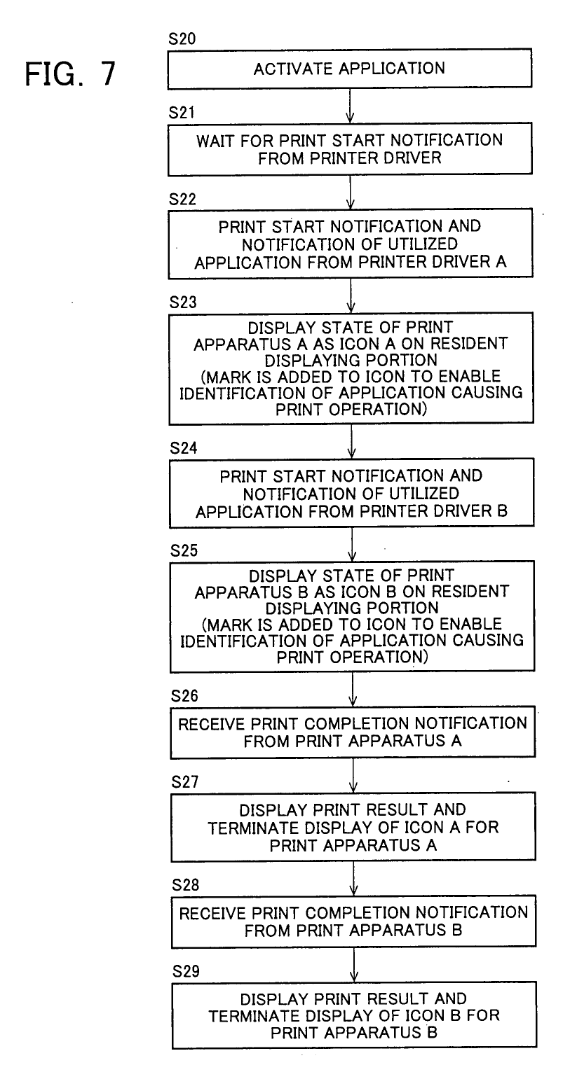

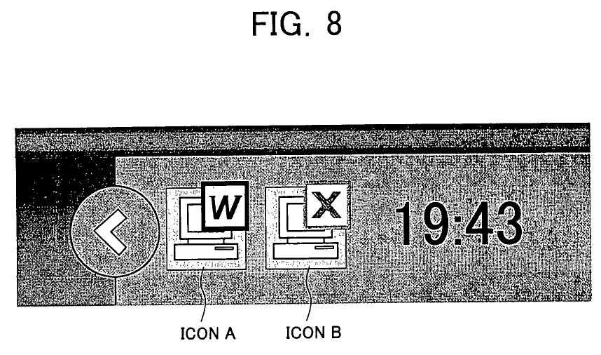

FIGS. 7 and 8 are explanatory diagrams of another embodiment and show a display example of adding marks enabling identification of types of the applications used for the printing. An outline of the embodiment is described below with reference to the flow of FIG. 7, that is, in the same manner as in the case of FIG. 4, at the first step S20, a user activates the applications 10a and 10b on the terminal apparatus to display print data to be printed, etc.

At step S21, the printer driver 13A (FIG. 2) for the print apparatus 2A is selected and activated to use the print apparatus 2A (see FIG. 1) to print the print data of the application 10a displayed on the terminal apparatus, and the printer driver 13B for the print apparatus 2B is selected and activated to use the print apparatus 2B to print the print data of the application 10b. While these print drivers are activated, the terminal apparatus 1 is in the waiting state for a print start notification.

When the printer driver 13A of the terminal apparatus is activated and the print apparatus 2A enters into the operation start state, a print start notification and a utilized application notification are sent out from the printer driver 13A at step S22. The icon A is appeared and displayed on the resident displaying portion of the displaying portion of the terminal apparatus to display that the print apparatus 2A is in the operating condition at step S23, and a mark is added to the icon A to enable identification of the application that sends the print instruction. For example, this mark is displayed as a mark “W” overlaps the icon A if the application is a Word document and this mark is displayed as a mark “X” overlaps the icon A if the application is an Excel document.

When the printer driver 13B is then activated and the print apparatus 2B enters into the operation start state, a print start notification is sent out from the printer driver 13B at step S24. The icon B with a mark indicating the utilized application added is generated and displayed on the resident displaying portion of the displaying portion of the terminal apparatus to display that the print apparatus 2B is in the operating condition at step S25 such that the icon B is arranged next to the icon A which is already displayed.

If the printing of the print apparatus A is completed, the print completion notification is sent out from the print apparatus A at step S26, and the terminal apparatus receives this notification. When receiving this print completion notification, at step S27, the print result of the print apparatus A is displayed on the displaying portion of the terminal apparatus and the display of the icon A indicating the print apparatus A is terminated on the resident displaying portion. When the print completion notification is sent out from the print apparatus B and received by the terminal apparatus, the print result of the print apparatus B is displayed on the displaying portion of the terminal apparatus, and the display of the icon B indicating the print apparatus B is terminated on the resident displaying portion at steps S28 and S29 in the same manner as that in the case of steps S26 and S27.

FIG. 8 depicts a display example of adding types of the utilized applications to the icons of the print apparatuses such that the types can be identified on the resident displaying portion of the terminal apparatus described in the above flow. In FIG. 8, the icon A corresponds to the print apparatus A and it is displayed by overlapping on the upper right portion of the icon A that the utilized application is a Word document. The icon B corresponds to the print apparatus B and it is displayed by overlapping on the upper right portion of the icon B that the utilized application is an Excel document. The icons A and B are displayed to line up next to next and can display that the print apparatuses A and B corresponding to the icons A and B are currently used by the terminal apparatus and in the print operations.

Other applications include Ichitaro documents, PDF documents, and PowerPoint documents, and if such marks are added, the print apparatuses can be related to the applications of the print documents and the print status can easily be identified. Since a user who monitors the print status can visually recognize the types of the utilized application, he can monitor the status with some expectation of the printed forms of documents. In some cases, a plurality of applications may be mixed in one document, and the mark of application may be changed on the way.

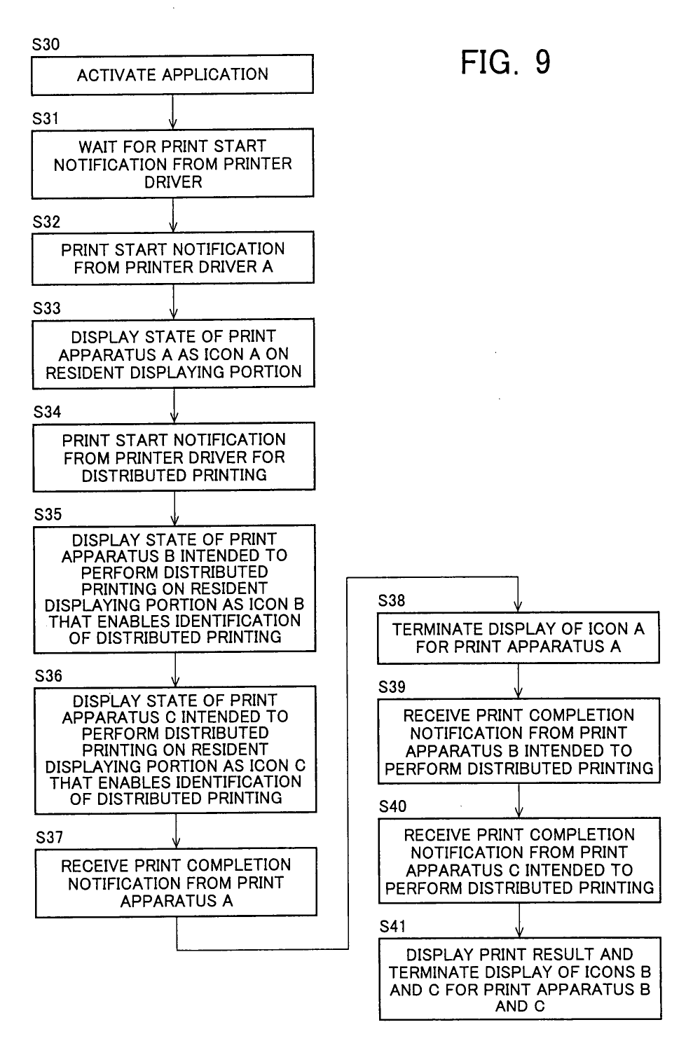

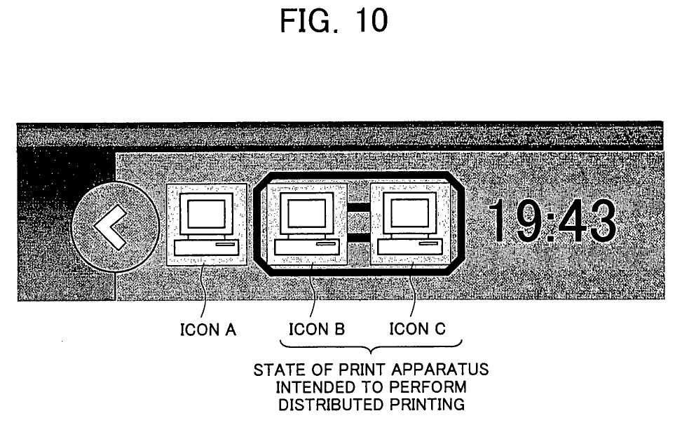

FIGS. 9 and 10 are explanatory diagrams of another embodiment and show an example of driving each print apparatus indicated by the icon to perform the distributed printing. An outline of the embodiment is described below with reference to the flow of FIG. 8, that is, in the same manner as that in the case of FIG. 4, at first step S30, a user activates the applications 10a and 10b on the terminal apparatus to display print data to be printed, etc.

At step S31, the printer driver 13A (FIG. 2) for the print apparatus 2A is selected and activated to use the print apparatus 2A (see FIG. 1) to print the print data of the application 10a displayed on the terminal apparatus. To print the print data of the application 10b, the printer driver 13R for the distributed printing is selected and activated to use the print apparatuses 2B and 2c. While these print drivers are activated, the terminal apparatus 1 is in the waiting state for the print start notification.

When the printer driver 13A of the terminal apparatus is activated and the print apparatus 2A enters into the operation start state, the print start notification is sent out from the printer driver 13A at step S32. The icon A is generated and displayed on the resident displaying portion of the displaying portion of the terminal apparatus to display that the print apparatus 2A is in the operating condition at step S33.

When the printer driver 13R for the distributed printing is then activated and the print apparatuses 2B and 2C intended to perform the distributed printing enter into the operation start state, the print start notification is sent out from the printer driver 13R at step S34. Icons B and C are generated and displayed to display that the print apparatus 2B enters into the operation condition at step S35 and that the print apparatus 2C enters into the operation condition at step S36, respectively, in the display forms different from the icon A already displayed on the resident displaying portion of the displaying portion of the terminal apparatus.

If the printing of the print apparatus A is completed, the print completion notification is sent out from the print apparatus A at step S37, and the terminal apparatus receives this notification. When receiving this print completion notification, the print result of the print apparatus A is displayed on the displaying portion of the terminal apparatus at step S38, and the display of the icon A displayed for the print apparatus A is terminated on the resident displaying portion. At steps S39 and S40, the print completion notification is sent out from the print apparatus B and the print completion notification is sent out from the print apparatus C. When the terminal apparatus receives the print completion notifications of the print apparatuses B and C, the print results of the print apparatuses B and C are displayed on the displaying portion of the terminal apparatus at step S41, and the display of the icons B and C corresponding to the print apparatuses B and C is terminated on the resident displaying portion.

FIG. 10 depicts a display example of icons of the print apparatuses utilized in the distributed printing, which are displayed in distinction from the icons of another print apparatus on the resident displaying portion of the terminal apparatus described in the above flow. In FIG. 10, the icon A corresponds to the print apparatus A and displays that the printing is performed in a normal method not performing the distributed printing. On the other hand, the icons B and C correspond to the print apparatuses B and C that perform the distributed printing of the same print data, and the icons B and C are displayed distinctively from the icon A of the print apparatus A, which is not included in the distributed printing, for example, by surrounding the icons B and C with a frame or coupling them or by dividing into color-coded groups to represent an image of the icons B and C performing the distributed printing. If a plurality of distributed printings is performed, each distributed printing is displayed in a grouped state and, for example, colors or background colors of the icons of the groups or are differentiated from each other such that one distributed printing group can be distinguished from another distributed printing group.

In the flow diagram of FIG. 9, the timings of completing the printing may be different between the print devises B and C that perform the distributed printing of the same print data (steps S39 and S40). In such a case, it is preferable that the completion of the printing is displayed when the printing are completed in all the print apparatuses included in the distributed printing. In the case of the distributed printing, if the print completion notification is sent and displayed when the printing is completed earlier by one print apparatus for the distributed printing, a user may go to pick up the printed sheets even though the printing is not completed by the other print apparatus for the distributed printing. As a result, the user may have to go to pick up the printed sheets again when the printing is completed by the other print apparatus. To eliminate such vain efforts, it is desirable to display the completion of the printing when all the print apparatuses complete the printing as described above.

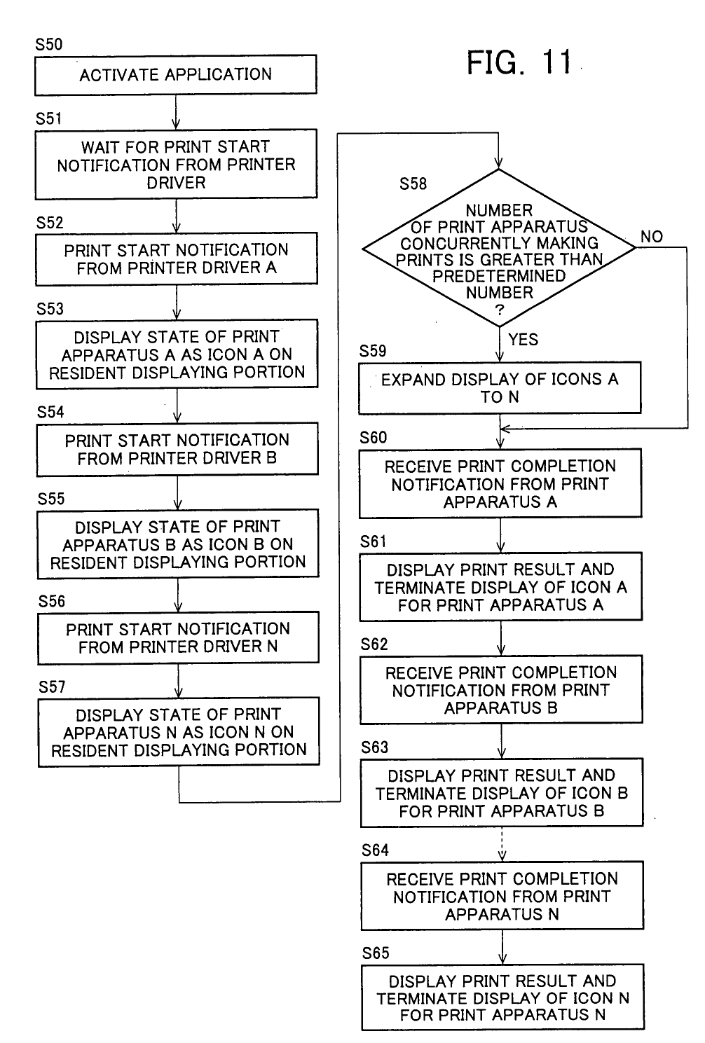

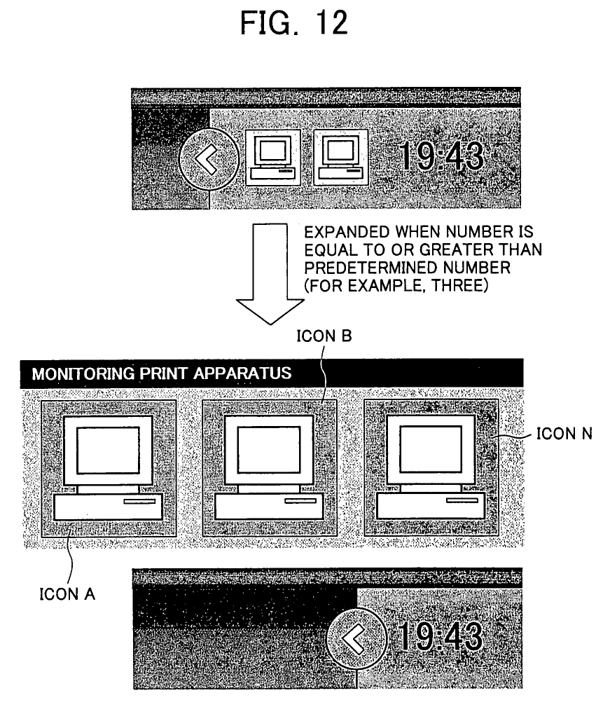

FIGS. 11 and 12 are explanatory diagrams of another embodiment and show an example when the number of the print apparatuses displayed by the icons exceed the predetermined number. An outline of the embodiment will be described with reference to a flow of FIG. 11. In the same manner as that in the case of the example of FIG. 4, at first step S50, a user activates the applications 10a, 10b . . . on the terminal apparatus to display print data to be printed, etc.

At step S51, the printer driver 13A (FIG. 2) for the print apparatus 2A is selected and activated to use the print apparatus 2A (see FIG. 1) to print the print data of the application 10a displayed on the terminal apparatus, and the printer driver 13B for the print apparatus 2B is selected and activated to use the print apparatus 2B to print the print data of the application 10b. It is assumed that the print apparatuses C . . . and a plurality of corresponding printer drivers (not shown) for the print apparatuses are subsequently selected and activated. While these print drivers are activated, the terminal apparatus is in the waiting state for a print start notification.

When the printer driver 13A of the terminal apparatus is activated and the print apparatus 2A enters into the operation start state, the print start notification is sent out from the printer driver 13A at step S52. The icon A is generated and displayed on the resident displaying portion of the displaying portion of the terminal apparatus to display that the print apparatus 2A is in the operating condition at step S53. When the printer driver 13B is then activated and the print apparatus 2B enters into the operation start state, the print start notification is sent out from the printer driver 13B at step S54. The icon B is generated and displayed on the resident displaying portion of the displaying portion of the terminal apparatus to display that the print apparatus 2B is in the operating condition at step S55 such that the icon B is arranged next to the icon A which is already displayed.

The above steps are executed for a plurality of the print apparatuses and the print drivers therefor, and the print start notification is sent out from the last print driver 13N at step S56. The icon N is generated and displayed on the resident displaying portion of the displaying portion of the terminal apparatus to display that the print apparatus 2N is in the operating condition at step S57 such that the icon N is lined up with the icons A, B . . . which are already displayed.

It is then decided whether or not the number of the utilized print apparatuses are equal to or greater than the predetermined number at step S58. If the number is equal to or smaller than the predetermined number (NO), the process goes to step S60, and if the number is greater than the predetermined number (YES), the icons A, B . . . displayed on the resident displaying portion are taken out from the resident displaying portion for enlarged display at step S59. Therefore, the unclearness on the display due to the increase in the number of icons can be eliminated.

If the printing of the print apparatus A is completed, the print completion notification is sent out from the print apparatus A at step S60, and the terminal apparatus receives this notification. When receiving this print completion notification, the print result of the print apparatus A is displayed on the displaying portion of the terminal apparatus at step S61, and the display of the icon A indicating the print apparatus A is terminated on the resident displaying portion. When the print completion notification is sent out from the print apparatus B and received by the terminal apparatus, the print result of the print apparatus B is displayed on the displaying portion of the terminal apparatus, and the display of the icon B indicating the print apparatus B is terminated on the resident displaying portion at steps S62 and S63 in the same manner as that in the case of steps S60 and S61.

Steps S60 to S63 described above are executed for a plurality of the print apparatuses, and the print completion notification is sent out from the last print apparatus N at step S64 and received by the terminal apparatus. When receiving this print completion notification, the print result of the print apparatus N is displayed on the displaying portion of the terminal apparatus at step S65, and the display of the icon N indicating the print apparatus N is terminated on the resident displaying portion.

FIG. 12 depicts a display example when the number of the utilized print apparatuses are equal to or greater than the predetermined number and the icons thereof are displayed on the resident displaying portion of the terminal apparatus as described in the above flow. In FIG. 12, for example, if the number of the print apparatus icons arranged on the resident displaying portion become three or more, only the display of the icons is taken out from the resident displaying portion and is enlarged and displayed on an available display screen area of the terminal apparatus.

When a lot of similar icons for print apparatuses are arranged on the resident displaying portion with a small display area, it is difficult to recognize each operation state. Therefore, if it becomes difficult to distinguish the icon from each other due to the increase of the number of icons, it is preferable to facilitate identification by displaying the expanded icons as described above. The number of the expanded icons may arbitrarily be determined according to a size of the display screen of the terminal apparatus or the display area of the resident displaying portion.

The above described a configuration of the print apparatus monitoring according to the present invention can be established as a print apparatus monitoring system in which a plurality of print apparatuses connected through the network perform printing in accordance with a print instruction from the terminal apparatus and the state of the print apparatuses is monitored by the terminal apparatus. In this case, the above configuration can be realized by a print apparatus monitoring system that displays the operation state of a plurality of the print apparatuses instructed to perform printing as separate icons corresponding to the respective apparatuses on the resident displaying portion of the terminal apparatus.

The present invention can be implemented by a program operating a computer to execute a print apparatus monitoring method in which a plurality of print apparatuses connected through the network performs printing in accordance with a print instruction from the terminal apparatus and displays the operation state of a plurality of the print apparatuses instructed to perform printing as separate icons corresponding to the respective apparatuses on the resident displaying portion of the terminal apparatus.

According to the present invention, if a plurality of print apparatuses is instructed to perform printing by the terminal apparatus, all the operating print apparatuses are displayed as icons on the resident displaying portion and the operation state thereof can always be monitored. The network traffic can be reduced and the load of the terminal apparatus can be alleviated by executing the display only during the operation of the print apparatuses. Changing the display form of the icons enables identification of the print apparatuses and identification of print forms, such as the distributed printing, and can facilitate the monitoring.

1. A print apparatus monitoring method of making prints with a plurality of print apparatuses connected through a network in accordance with a print instruction from a terminal apparatus and monitoring the state of the print apparatuses with the terminal apparatus,
the method comprising the step of displaying the operation state of the plurality of the print apparatuses instructed to make prints by separate icons corresponding to the respective print apparatuses on a resident displaying portion of the terminal apparatus.

2. The print apparatus monitoring method as defined in claim 1, wherein occurrence of an error in the print apparatuses is displayed by changing the display form of the corresponding icon.

3. The print apparatus monitoring method as defined in claim 1, wherein the display of the icon is displayed according to a print start notification of each of the plurality of the print apparatuses.

4. The print apparatus monitoring method as defined in claim 1, wherein the display of the icon is erased according to a print completion notification of each of the plurality of the print apparatuses.

5. The print apparatus monitoring method as defined in claim 1, wherein the display of the icons are displayed so that the plurality of the print apparatuses can be identified.

6. The print apparatus monitoring method as defined in claim 1, wherein the display of the icons are displayed with marks added to enable identification of a type of application used for the printing of each of the print apparatuses.

7. The print apparatus monitoring method as defined in claim 1, wherein the display of the icons are displayed by grouping a plurality of print apparatuses performing distributed printing of the same print data so that the display can be distinguished from the display of a print apparatus which independently makes prints of different print data.

8. The print apparatus monitoring method as defined in claim 1, wherein a print completion notification is displayed when the printing is completed in all the print apparatuses performing the distributed printing of the same print data.

9. The print apparatus monitoring method as defined in claim 1, wherein when the number of the concurrently operating print apparatuses becomes equal to or greater than a predetermined number, the display area of the icon display is expanded.

10. A print apparatus monitoring system in which a plurality of print apparatuses connected through a network make prints according to a print instruction from a terminal apparatus and the terminal apparatus monitors the state of the print apparatuses,
wherein the operation states of the plurality of the print apparatuses instructed to make prints are displayed as separate icons respectively corresponding to the print apparatuses on a resident displaying portion of the terminal apparatus.

11. A program which operates on a computer to execute a print apparatus monitoring method in which a plurality of print apparatuses connected through a network make prints according to a print instruction from a terminal apparatus and the operation states of the plurality of the print apparatuses instructed to make prints are displayed as separate icons respectively corresponding to the print apparatuses on a resident displaying portion of the terminal apparatus.
